(19) United States
(12) Patent Application Publication
(10) Pub. No.: US 2026/0264605 A1
(43) Pub. Date: Sep. 10, 2026

(54) ILLUMINATED SEAT BELT BUCKLE FOR A SEAT BELT DEVICE OF A MOTOR VEHICLE

(71) Applicant: Autoliv Development AB, Vargarda (SE)

(72) Inventors: Michel HERMANN, Pinneberg (DE); Timo NEHRENHEIM, Hamburg (DE); Iulian ROTARIU, Kölln-Reisiek (DE); Leif SCHATTAUER, Elmshorn (DE)

(21) Appl. No.: 19/167,693

(22) PCT Filed: Mar. 21, 2024
(86) PCT No.: PCT/EP2024/057655

§ 371 Date: Sep. 22, 2025

(30) Foreign Application Priority Data
Mar. 22, 2023 (DE) 10 2023 107 195.5

(51) Int. Cl. B60Q 3/242; B60Q 3/80; B60R 22/18; F21V 3/04; F21Y 105/18; F21Y 115/10; F21Y 115/15

(52) U.S. Cl. CPC B60Q 3/242; B60Q 3/80; B60R 22/18; F21V 3/04; B60R 2022/1806; F21Y 2105/18; F21Y 2115/10; F21Y 2115/15

(57) ABSTRACT

An illuminated seat belt buckle for a seat belt device of a motor vehicle, comprising a housing, a push button which can be moved in the housing, an insert slot for inserting a belt tongue which can be locked in the seat belt buckle, and at least one annular light source which surrounds the insert slot and the push button, and a cover element which covers the annular light source towards the radial outer face and the end face of the seat belt buckle, wherein the light source is made of a plurality of individual light sources which can be actuated independently of one another.

The present invention relates to an illuminated seat belt buckle for a seat belt device of a motor vehicle, having the features of the preamble of claim 1.

Seat belt buckles for seat belt devices of motor vehicles serve in general to securely lock to a vehicle a belt tongue movably guided on a belt webbing or securely connected to an end of a belt webbing. For this purpose, the seat belt buckle has an insertion slot for the belt tongue and a locking mechanism which can be released via a push button. The locking mechanism is spring-loaded and automatically locks the belt tongue upon insertion into the insertion slot. To release the belt tongue, the passenger buckled up with the seat belt presses down the push button, whereby the locking mechanism is released, and the belt tongue is ejected by a released spring force of the locking mechanism.

Such seat belt buckles have been prior art for many years. A problem with such seat belt buckles is that, to buckle up, the occupant has to find the comparatively narrow insert slot of the seat belt buckle into which he inserts the belt tongue for fastening the seat belt.

It is known from DE 39 04 125 A1 to provide a seat belt buckle with a light source, wherein the light source is coupled to predetermined light-emitting surfaces of the seat belt buckle via a light-conducting material. The light-emitting surfaces in this case are the push button itself and/or a radiating surface arranged on a side face of the insert slot opposite the push button. Since the push button must for its function be designed to be displaceable, the light-conducting material fixedly arranged in the push button must be positioned in the push button in such a way that the light entry surface of the light-conducting material is photometrically connected to the external light source when the push button is in the non-pressed position. If the light entry surface of the light-conducting material in this position is not photometrically connected to the external light source due to production-related shape and position deviations or mechanical influences, the light is not or not completely fed into the push button, such that the push button itself does not illuminate, or illuminates more weakly than desired.

It is further known from DE 10 2007 047 704 A1 to provide a light conductor in the seat belt buckle, which light conductor has at least two light-emitting surfaces arranged at the ends of the insert slot. The light-emitting surfaces themselves are triangular in shape and arranged in a free triangular area of the front side of the housing between the edge of the housing and a conical side face of the push button. The light-emitting surfaces are dimensioned in particular in such a way that they fill the free areas in the corners of the front side of the housing as extensively as possible in order to achieve the best possible luminosity.

From U.S. Pat. No. 5,892,436 A, an illuminated seat belt buckle is known in which a light source is connected via a plurality of light conductors, wherein the light conductors emerge at an end face of the housing and therefore form a plurality of luminous points which are circumferentially arranged around the push button of the seat belt buckle or around the insert slot. However, this solution is complex and expensive, and the light conductors are located in the direction of movement of the push button such that there is a risk of damage to the light conductors when the push button is operated to open the seat belt buckle.

From the document DE 10 2015 215 254B4, an illuminated seat belt buckle is known in which the light-emitting surface is formed by a circumferential surface light source on the end face of the housing, wherein the surface light source is designed as a luminous thin-film component. In this case, an additional ring element is provided on the end face of the housing and covers the surface light source from the end face of the seat belt buckle and from the radial outer face of the seat belt buckle and thereby protects it from damage. The ring element is manufactured in a two-component injection-molding process and has a translucent region on the end face in the form of a continuous circumferential band and an opaque region on its radial outer face so that the seat belt buckle is deliberately illuminated only on the end face.

The object of the invention is to provide an economical seat belt buckle of the generic type with improved lighting.

In order to achieve the object, an illuminated seat belt buckle with the features of claim 1 is proposed. Further preferred embodiments of the invention can be found in the dependent claims, the figures, and the associated description.

According to claim 1, an illuminated seat belt buckle for a seat belt device of a motor vehicle is proposed, having a housing, a push button which can be moved in the housing, an insert slot for inserting a belt tongue which can be locked in the seat belt buckle, and at least one annular light source which surrounds the insert slot and the push button, and a cover element which covers the annular light source toward the radial outer face and the end face of the seat belt buckle, wherein the light source is made of a plurality of individual light sources which can be actuated independently of one another.

The advantage of the proposed solution is that the large number of individual light sources which can be actuated independently of one another allows for individually different lighting of the seat belt buckle depending upon the actuation of the individual light sources. In this way, different lighting patterns, lighting frequencies, or even dynamic lighting, e.g., in the form of a running light, can be realized. The individual lighting can be implemented differently both according to aesthetic aspects and depending upon the buckling conditions, seat occupancy conditions in the vehicle, driving conditions, or accident scenarios. Furthermore, the proposed solution has the advantage of redundancy in that, in the event of a failure of individual light sources, the lighting of the seat belt buckle is provided by the still-functional individual light sources.

The individualized lighting of the seat belt buckle can be further improved by having individual light sources emit light at different light intensities and/or colors. This can be achieved, for example, in that at least two of the individual light sources emit light at a different light intensity and/or color, or in that the individual light sources themselves are actuated to emit light at a different light intensity and/or color. This allows different and/or changing color patterns of the lighting of the seat belt buckle lighting to be realized. The individual light sources can be designed in such a way that they radiate light at a different light intensity and/or color, wherein the light intensity and/or color of the light radiated by the individual light sources is unchangeable. Alternatively, the individual light sources can also be designed in such a way that they can emit light at different light intensity and/or color depending upon their actuation. By designing the light intensity of the individual light sources, a different lighting of the cover element can be made possible, which, taking into account the locally different light permeability of the cover element, can be used to further improve homogeneous lighting of the seat belt buckle.

It is further proposed that the individual light sources be connected to one another by a carrier material to form the annular light source. Due to the carrier material, the individual light sources form a composite and can be mounted together in a single insertion process. The carrier material thereby forms the mechanical composite of the individual light sources.

In this case, an electrical conductor structure can preferably be provided in the carrier material, to which the individual light sources are electrically connected. The electrical contact between the individual light sources is achieved through the conductor structure in the carrier material, wherein the conductor structure itself is mechanically supported or embedded in the carrier material.

It is further proposed that the individual light sources have a central, common power supply. This means that the individual light sources are supplied with power via a single electrical contact, which must be created when the seat belt buckle is installed. The contact can be implemented as a plug contact or by a soldering point.

It is further proposed that a LIN controller be provided to control the individual light sources. LIN controllers are very economical to produce in large quantities and enable a very simple conductor structure for actuating the individual light sources.

It is further proposed that the individual light sources be formed by OLED segments or by LED's. OLED segments and LED's have the advantage of very good controllability with, at the same time, a very long service life. Furthermore, OLED segments and LED's can be manufactured as mass-produced goods and fixed to the carrier material very economically.

It is further proposed that the cover element have a different light permeability. Due to the different light permeability of the cover element, the emission characteristics of the illuminated seat belt buckle can be changed independently of the light intensity and the color of the light emitted by the individual light sources, in that the cover element has a higher light permeability in certain zones or portions and a lower light permeability in certain zones or portions. The portions of different light permeability can be designed in such a way that the light permeability of the cover element changes gradually or even continuously at the transition between the portions.

In this case, a particularly optically homogeneous lighting of the seat belt buckle can be achieved in that the cover element has a lower light permeability in the portions covering the individual light sources than in the portions covering the portions between the individual light sources. Therefore, the different light intensity of the light source caused by the individual light sources is compensated for by the proposed configuration of the light permeability of the cover element to ensure homogeneous light emission. In this regard, the uneven distribution of the light intensity of the emitted light from the light source is due to the fact that the individual light sources emit the light locally at a high light intensity, while the light intensity of the light source is lower in the portions between the individual light sources.

It is further proposed that the cover element be formed integrally from a translucent material. The proposed solution has the advantage that the light is emitted via the cover element both toward the end face of the seat belt buckle and radially toward the outside, wherein this is made possible solely by the integral design of the cover element and its translucent design. This makes the proposed solution particularly economical, while simultaneously improving the lighting of the seat belt buckle.

It is further proposed that the cover element have an integrally formed fastening attachment with which it is fastened to the housing of the seat belt buckle. This makes the attachment of the cover element and the associated installation process particularly simple and economical. To fasten the cover element, a corresponding fastening surface is provided on the housing of the seat belt buckle, which enables the cover element to be fastened via its fastening attachment.

It is further proposed that the fastening attachment have a latching hook with which it is latched to an undercut of the housing. Latching is advantageous because it can be done very easily during installation and does not require any additional fastening means.

It is further proposed that the housing have a closed annular portion which surrounds the insert slot and the push button, which portion delimits an annular cavity toward the radial inner face, wherein the annular cavity is delimited by the cover element toward the radial outer face and toward the end face of the seat belt buckle, and the light source is arranged in the annular cavity. The cover element therefore encloses a cavity in the housing in which the light source is arranged. Since the cover element is translucent, while the housing of the seat belt buckle is otherwise opaque, this ensures that all of the light emitted by the light source exits to the outside exclusively through the cover element. This means that the lighting of the seat belt buckle is defined exclusively by the cover element. In this case, to achieve high-quality optical lighting of the seat belt buckle, the shape of the cover element, on the one hand, and its translucent properties, on the other, can be specifically designed.

In this regard, it is proposed that the cover element preferably rest against the annular portion of the housing in the region of the end face of the seat belt buckle, so that further parts are not required to form the cavity.

It is further proposed that the annular portion protrude from a base surface of the housing, and the cover element rest radially outwards on a portion of the housing forming the base surface. The cavity is therefore formed by the cover element, the annular portion, and the base surface, wherein the annular portion and the base surface are part of the housing and form the inner wall of the cavity, and the cover element covers the cavity toward the outside.

It is further proposed that the light source be annular and be arranged on the base surface radially outwards toward the annular portion of the housing. The proposed annular design of the light source and its arrangement on the base surface allows the cavity and therefore the cover element to be illuminated particularly evenly.

It is further proposed that the cover element have an integrally formed light-conducting portion which has a light entry surface arranged in parallel and opposite to a light-emitting surface of the light source. Due to the integrally formed light-conducting portion with the proposed arrangement of its light entry surface, the light emitted by the light source is coupled into the cover element with an improved yield, wherein the light conductor specifically creates a light-conducting connection from the light entry surface to the radially outer radiating surface of the cover element.

It is further proposed that a gap be provided between the integrally formed light-conducting portion and a radially outer edge of the cover element. Through the gap, the cover element can perform slight spring movements with its outer edge toward the light-conducting portion, which can be used to fasten the cover element during installation. This is in particular advantageous because the light-conducting portion greatly stiffens the cover element due to its volume, which is compensated for by the spring elasticity of the edge of the cover element created by the gap.

It is further proposed that the light source be formed by an annular light conductor which rests against the radial outer face of the annular portion and has a light exit surface. The annular light conductor forms a light source with its light exit surface, wherein the light exit geometry is defined by the light exit surface created thereon. To feed in the light itself, the light conductor is connected to an external light source which can be arranged either in the housing of the seat belt buckle or in the cavity or at any external location at which the light is coupled into the light conductor.

The light conductor is preferably designed with a partially circular cross-section, wherein the light exits from the light conductor both toward the radial outer face of the seat belt buckle and toward the end face of the seat belt buckle. This illuminates the cavity between the cover element and the annular portion or the cover element radially outwards and in the direction of the end face of the seat belt buckle.

It is further proposed that the cover element be arranged contactlessly with respect to the light source. The contactless arrangement of the light source to the cover element prevents the light source from being exposed to mechanical stress when the cover element is attached. Furthermore, the contactless arrangement of the cover element is advantageous for homogeneous lighting of the cover element, since the light radiated by the light source is additionally distributed before entering the cover element.

The invention is explained below using preferred embodiments with reference to the accompanying figures, in which:

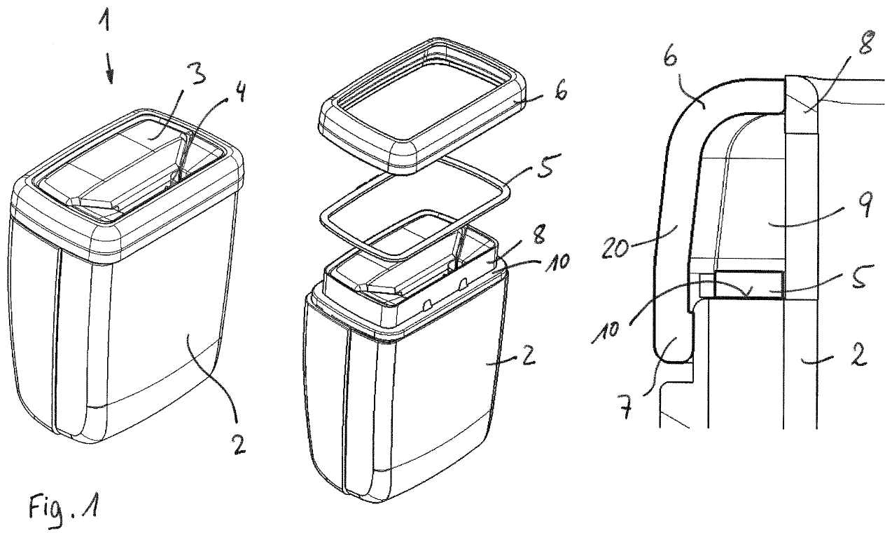

FIG. 1 shows a seat belt buckle according to the invention according to a first exemplary embodiment; and

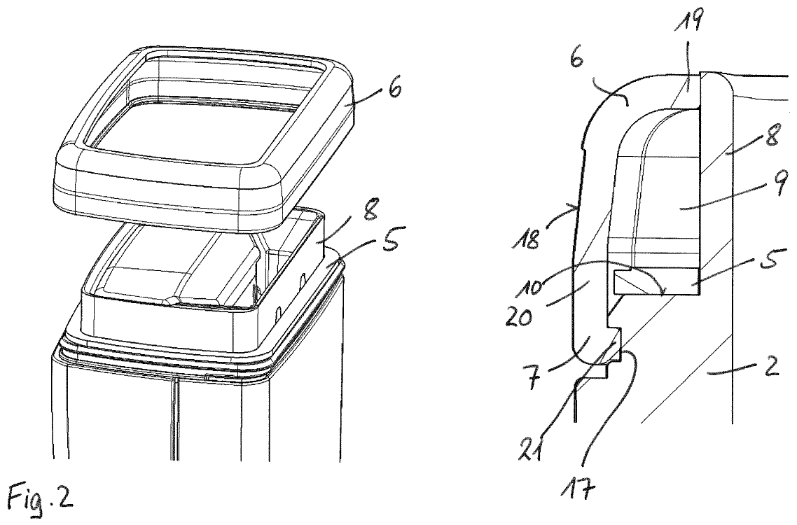

FIG. 2 shows the seat belt buckle according to the invention of FIG. 1 in a preferred further development; and

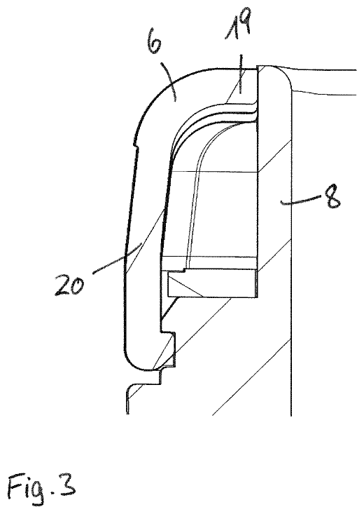

FIG. 3 shows the seat belt buckle according to the invention of FIG. 1 with a cover element of various thicknesses; and

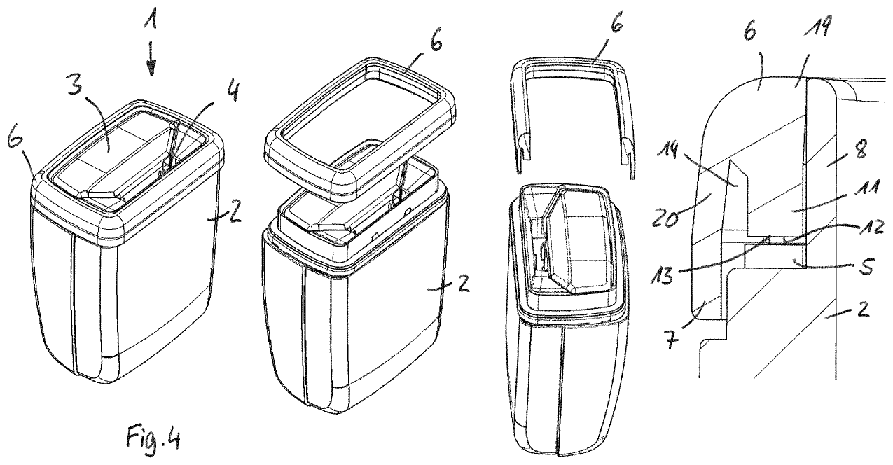

FIG. 4 shows a seat belt buckle according to the invention with a cover element with an integrated light conductor according to a second exemplary embodiment; and

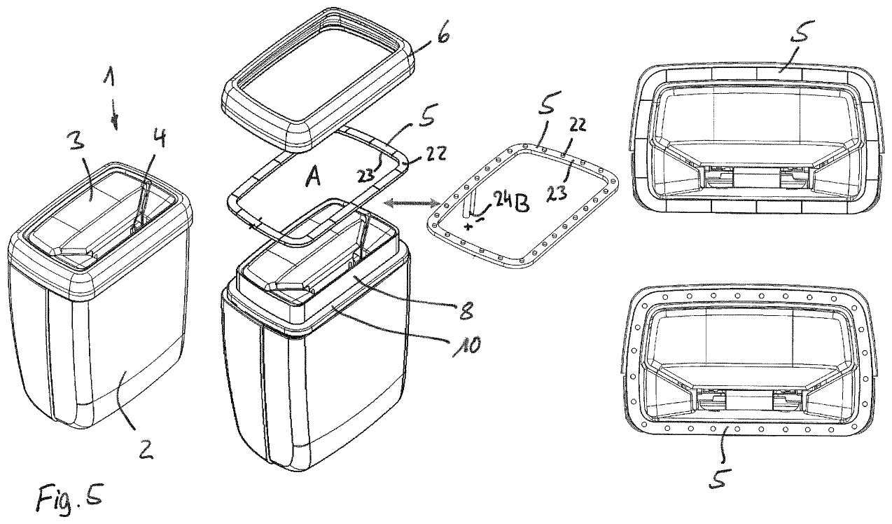

FIG. 5 shows a seat belt buckle according to the invention with a light source with a plurality of individual light sources; and

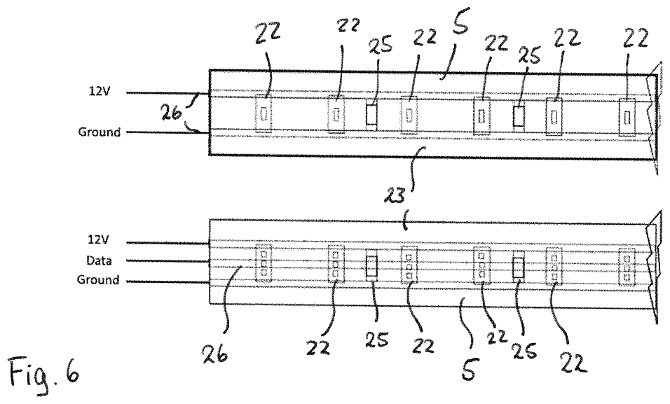

FIG. 6 shows a cutout of a light source with a plurality of individual light sources in an enlarged view.

In FIG. 1, an illuminated seat belt buckle 1 according to the invention can be seen with a housing 2, a push button 3 arranged on the end face, and an insert slot 4 arranged adjacent to the latter for inserting and locking a belt tongue (not shown) of a seat belt device. In the housing 2, a locking mechanism (not shown) is provided for locking the belt tongue, which can be released by actuating the push button 3 for ejecting the belt tongue in the described manner.

On the end face of the housing 2, a annular portion 8 is provided which protrudes from a base surface 10 of the housing 2 and which encloses the push button 3 and the insert slot 4 of the seat belt buckle 1. The base surface 10 of the housing 2 is also annular and extends over the entire circumference of the housing 2 on the radial outer face of the annular portion 8. Furthermore, a cover element 6, which is also annular, is provided, which is fastened to the outside of the housing 2 in the portion forming the base surface 10 via a fastening attachment 7. To fasten the cover element 6, it can be glued or welded, for example, to the fastening attachment 7 on the outside of the housing 2.

The cover element 6 extends from the fastening attachment 7 in a first portion 20 extending in the direction of the end face of the housing and continues from the first portion 20 via a curved portion into a second portion 19 which is directed on the end face of the housing 2 in the direction of the annular portion 8. The cover element 6 rests with the fastening attachment 7 radially on the outside on the housing 2 and with the end face of the second portion 19 on the annular portion 8. The cover element 6 therefore encloses an annular cavity 9 which is limited toward the radial inside by the annular portion 8 and toward the underside by the base surface 10. An annular light source 5 is arranged on the base surface 10 of the cavity 9. The light sources 5 can be surface light sources, LED chains, or light conductors with corresponding light exit surfaces.

The cover element 6 is formed integrally from a translucent material. When the light source 5 is activated, the cavity 9 is completely illuminated, wherein the light exits to the outside through the first portion 20, the second portion 19, and the curved portion of the cover element 6 arranged therebetween due to the integral, translucent design of the cover element 6. The seat belt buckle 1 is therefore homogeneously illuminated annularly over the entire outer surface of the first portion 20, the second portion 19, and the curved portion of the cover element 6, wherein the push button 3 and the insert slot 4 are arranged within the luminous ring. Since the cover element 6 with the fastening attachment 7 on the outside of the housing 2 and with the second portion 19 lies flat and, as far as possible and in the context of the possible manufacturing accuracy, without a gap on the annular portion 8, the light exits to the outside exclusively via the outer surface of the cover element 6, so that an optically high-quality lighting of the seat belt buckle 1 can be realized. Depending upon the customer's requirements, the emission characteristics can be changed by deliberately roughening the cover element 6—for example, by etching the surface or by a specific embossed surface structure on its radial outer face or also on its radial inner side in order to increase the scattering of the light. It is also conceivable to provide a partially transparent coating of the cover element 6, which allows the light to exit when the light source 5 is activated, but prevents a view through the cover element 6 when the light source 5 is deactivated.

In FIG. 2, a further developed design of the exemplary embodiment of FIG. 1 can be seen. The fastening attachment 7 is formed here by a latching arm which latches into a groove 17 of the housing 2 to fasten the cover element 6. The latching arm and/or the groove 17 can be formed both over the entire circumference of the housing 2 or the cover element 6, or only sectionally in the form of several latching arms and several grooves 17 spaced apart from each other. Furthermore, the cover element 6 is deliberately provided, in the region of the first portion 20, with a portion 18 in which additional logos of the customer or information symbols of another type can be provided.

In FIG. 3, a further development of the exemplary embodiment of FIG. 1 can be seen in which the cover element 6 can have different thicknesses in the region of the second portion 19. Depending upon the desired emission characteristic, the cover element 6 can be made thicker or thinner in the second portion 19, wherein the cover element 6 remains unchanged in the region of the first portion 20 and the fastening attachment 7. It is also conceivable to design the cover element 6 circumferentially with different thicknesses in the region of the second portion 19, so that the cover element 6 has different emission characteristics along its circumference. This also allows the rigidity of the cover element 6 to be varied over the circumference.

In FIG. 4, a further development of the exemplary embodiment of FIG. 1 can be seen, in which the cover element 6 has an integrally formed light-conducting portion 11. Otherwise, the cover element 6 can be designed, in particular in the region of the fastening portion 7 and the first portion 20, according to the exemplary embodiment of FIG. 1. The light-conducting portion 11 extends into the cavity 9 and has a light entry surface 13 which is arranged parallel and opposite to a light-emitting surface 12 of the light source 5, forming a gap with a constant gap width.

The light-emitting surface 12 of the light source 5 is regarded as an idealized light-emitting surface, which, when the light source 5 is designed with a plurality of LED's, is regarded as the plane in which the LED's are arranged. If the light source 5 is a surface light source, the light-emitting surface is the surface of the surface light source. If the light source 5 is designed in the form of a light conductor, the light-emitting surface 12 is the average plane of the light exit surface of the light conductor.

The cover element 6 further has a gap 14 that is between the light conductor 11 and the first portion 20 of the outer wall of the cover element 6 and which allows the fastening portion 7 to spring out radially outwards when the cover element 6 is fastened.

The light radiated by light source 5 is then emitted via the light-emitting surface 12 and coupled into the light guide via the oppositely arranged light entry surface 13 of the light conductor 11. The light is then passed on in the light conductor 11 into the first portion 20, the second portion 19, and into the curved portion of the cover element 6 lying therebetween and is emitted via these to the outside.

FIG. 5 shows the seat belt buckle 1 of FIG. 1 with a light source 5 according to version A, which has a plurality of individual light sources 22 in the form of OLED's on a carrier material 23. The OLED's are arranged flat on the carrier material 23 and, when all OLED's are activated, together form a closed luminous ring on the surface of the light source 5. The OLED's can be actuated individually and independently of each other, so that a running light can be realized by a time-delayed, circumferentially successive activation of the individual neighboring OLED's. Furthermore, OLED's can also be designed in such a way that they emit light in different colors or change the color of the light they emit. The carrier material 23 serves to mechanically connect the OLED's and, in addition to contacting the OLED's, can have a conductor structure with a central connection to an external power supply.

Alternatively, according to version B, a light source 5 with a plurality of individual light sources 22 can be provided, which are formed by LED's. The LED's are combined on a carrier material 23 to form a “COB (chip on board) light strip.” A conductor structure for contacting the LED's is provided in the carrier material 23, such that the carrier material 23 can also be regarded as an annular, flexible circuit board. In addition to arranging the various electrical components, the carrier material 23 also serves to fasten the light source 5, e.g., by clipping it to the housing 2. The LED's can be designed either as monochrome LED's or as RGB LED's with a controllable color of the emitted light, wherein a mixture of such LED's can of course also be provided.

FIG. 6 shows an enlarged portion of a light source 5 according to two different embodiments with a plurality of individual light sources 22, wherein the individual light sources 22 are formed by monochrome LED's in the upper exemplary embodiment and by RGB LED's in the exemplary embodiment of the lower illustration. The carrier material 23 of the light sources 5 consists of an electrically insulating material and is a support for various electrical components such as the conductor structure 26, integrated resistors 25, and a LIN controller which serve to supply power and actuate the LED's. The resistors 25 are located in the power supply between the LED's and thereby enable a uniform brightness of the LED's and therefore of the light source 5. The conductor structure 26 in the carrier material 23 has two electrical contacts 24, which can be seen in FIG. 5, which are connected to two mating contacts of a central power supply via a solder connection, a crimp connection, or a plug connection such that the individual light sources 22 are also electrically connected to the central power supply by them.

If monochrome LED's are provided, they can be made to shine by a simple, controlled current supply of between 6 V or 12 V. If RGB LED's are provided, they are preferably controlled via the LIN controller with a LIN slave and a LIN master. In this regard, the LIN slave is provided on the carrier material 23, i.e., the circuit board, which, in addition to a plus-minus connection, is also connected via a data pole to a vehicle control unit, which in this case forms the LIN master for the LIN slave. The plus-minus connection of contacts 24 is additionally supplemented by a control line (data) which forms the data pole for the LIN controller.

By correspondingly actuating the LIN slave via the LIN master, certain data commands can be executed which serve to individually actuate the RGB LED's. This allows a wide variety of lighting concepts to be realized. For example, a circulating light point, permanent flashing of the LED light strip in any color, or even permanent illumination of the LED strip in the desired ambient lighting color can be realized.

The LED's are arranged centrally and in a row on the carrier material 23 and are each at an identical distance from each other. Therefore, the cavity 9 and the cover element 6 are illuminated evenly over the circumference, and the seat belt buckle 1 is accordingly illuminated evenly.

The individual light sources 22 can be actuated individually and independently of one another, regardless of whether they are designed as monochrome LED's, RGB LED's, or OLED's, wherein predefined lighting sequences, light intensities, and colors of the individual light sources 22 can be stored in a control program and retrieved to activate the light source 5. This allows different lighting concepts to be realized with respect to the color, the lighting duration, and the lighting rhythm of the individual light sources 22. The color of the emitted light, the lighting rhythm, and the light intensity of the individual light sources 22 are available for the design of the emission characteristics and the lighting concept of the seat belt buckle 1.

1. An illuminated seat belt buckle for a seat belt device of a motor vehicle, comprising
a housing,
a push button which can be moved in the housing,
an insert slot for inserting a belt tongue which can be locked in the seat belt buckle, and
at least one annular light source which surrounds the insert slot and the push button, and
a cover element which covers the annular light source toward the radial outer face and the end face of the seat belt buckle, wherein the light source is made of a plurality of individual light sources which can be actuated independently of one another.

2. The illuminated seat belt buckle according to claim 1, wherein the individual light sources emit light with a different light intensity and/or color.

3. The illuminated seat belt buckle according to claim 1, wherein the individual light sources are connected to one another by a carrier material (23) to form the annular light source.

4. The illuminated seat belt buckle according to claim 3, wherein in the carrier material, an electrical conductor structure is provided to which the individual light sources are electrically connected.

5. The illuminated seat belt buckle according to claim 1, wherein the individual light sources have a central, common power supply.

6. The illuminated seat belt buckle according to claim 1, wherein an LIN controller is provided to control the individual light sources.

7. The illuminated seat belt buckle according to claim 1, wherein the individual light sources are formed by OLED segments.

8. The illuminated seat belt buckle according to claim 1, wherein the individual light sources are formed by LED's.

9. The illuminated seat belt buckle according to claim 1, wherein the cover element is formed integrally from a translucent material.

10. The illuminated seat belt buckle according to claim 1, wherein the cover element has a different light permeability.

11. The illuminated seat belt buckle according to claim 10, wherein the cover element has a lower light permeability in the portions covering the individual light sources than in the portions covering the portions between the individual light sources.

12. The illuminated seat belt buckle according to claim 1, wherein the cover element has an integrally formed fastening attachment by means of which the cover element is fastened to the housing of the seat belt buckle.

13. The illuminated seat belt buckle according to claim 12, wherein the fastening attachment has at least one latching hook by means of which the fastening attachment is latched to an undercut of the housing.

14. The illuminated seat belt buckle according to claim 1, wherein the housing has a closed annular portion which encompasses the insert slot and the push button and delimits an annular cavity toward the radial inner side, wherein the annular cavity is delimited toward the radial outer face and toward the end face of the seat belt buckle by the cover element and the light source is arranged in the annular cavity.

15. The illuminated seat belt buckle according to claim 14, wherein the annular portion protrudes from a base surface of the housing, and the cover element rests radially on the outside on a portion of the housing that forms the base surface.

16. The illuminated seat belt buckle according to claim 15, wherein the light source is arranged on the base surface radially on the outside of the annular portion of the housing.

17. The illuminated seat belt buckle according to claim 1, wherein the cover element has an integrally formed light-conducting portion which has a light entry surface arranged in parallel with and opposite to a light-emitting surface of the light source.

18. The illuminated seat belt buckle according to claim 17, wherein a gap is provided between the integrally formed light-conducting portion and a radially outer edge of the cover element.

19. The illuminated seat belt buckle according to claim 1, wherein the cover element is arranged contactlessly with respect to the light source

20. The illuminated seat belt buckle according to claim 2, wherein the individual light sources are connected to one another by a carrier material to form the annular light source.
